(19) United States
(12) Patent Application Publication
(10) Pub. No.: US 2004/0242246 A1
(43) Pub. Date: Dec. 2, 2004

(54) Short message service request employment by application server component to obtain one or more mobile device short message service reports

(76) Inventors: Chinmei Chen Lee, Woodridge, IL (US); Douglas William Varney, Naperville, IL (US)

Correspondence Address: PATTI & BRILL, ONE NORTH LASALLE STREET, 44TH FLOOR, CHICAGO, IL, 60602, US

(21) Appl. No.: 10/448,739

(22) Filed: May 30, 2003

(51) Int. Cl. H04Q 7/20

(52) U.S. Cl. 455/466

(57) ABSTRACT

An application server component of an apparatus in one example sends one or more short message service (“SMS”) requests to a plurality of mobile devices. The application server component obtains one or more SMS reports from one or more of a plurality of mobile devices. The application server component sends one or more portions of information based on the one or more SMS reports to one or more communication devices.

### TECHNICAL FIELD

The invention relates generally to telecommunications and more particularly to short message service (“SMS”) based telecommunications.

### BACKGROUND

During times of heavy communication traffic, communication networks may become too busy to handle all communication attempts made by communication devices. The communication devices in one example comprise mobile communication devices such as mobile telephones, pagers, and/or personal digital assistants (“PDAs”). In an emergency situation a large number of people may attempt to communicate with others through the communication devices. For example, the large number of people attempt to place telephone calls to other people they know to alert the other people of their status and/or location. The telephone calls for example require dedicated channels for voice and/or data. The large number of telephone calls may overload the communication network. As one shortcoming, the dedicated channel for the telephone call uses a relatively large portion of communication network resources. As a further shortcoming, a large number of contemporaneous telephone calls may overload the communication network.

A short message service (“SMS”) allows users of the communication devices to send SMS text messages between the communication devices. The SMS messages in one example travel through signaling channels. For example, SMS text messages employ a smaller portion of the resources of the communication network than telephone calls. Therefore, the SMS text messages are less likely to overload the communication network.

A first SMS user in one example sends a SMS message to a short message service center (“SMSC”). The short message service center stores the SMS message for delivery to other SMS users. It can be difficult for the first SMS user to send SMS messages to a large number of other SMS users. In one example, the first SMS user may have difficulty determining which other SMS users should receive a specific SMS message. In another example, the first SMS user may unintentionally neglect to include an intended SMS user in the group of other SMS users to receive the specific SMS message. In yet another example, the first SMS user may be unable to input a command into the mobile communication device to include the intended SMS user in the group of other SMS users to receive the specific SMS message. For example, the first SMS user may be in a rush or physically unable to input the command into the mobile communication device. In still yet another example, a user may not have access to a mobile communication device with SMS message capabilities. Therefore, the user cannot receive SMS messages.

Thus, a need exists for a system that can receive SMS messages from a set of users and provide information of the SMS messages to other users. A further need exists for a system that can alert the other users of the status of the set of users.

### SUMMARY

The invention in one embodiment encompasses an apparatus. The apparatus comprises an application server component that sends one or more short message service (“SMS”) requests to a plurality of mobile devices. The application server component obtains one or more SMS reports from one or more of a plurality of mobile devices. The application server component sends one or more portions of information based on the one or more SMS reports to one or more communication devices.

Another embodiment of the invention encompasses a method. One or more short message service requests are sent to a plurality of mobile devices. One or more SMS reports are received from one or more of the plurality of mobile devices in response to the one or more SMS requests. One or more portions of information based on the one or more SMS reports are accessed by one or more communication devices.

Yet another embodiment of the invention encompasses an article. The article comprises one or more computer-readable signal-bearing media. The article comprises means in the one or more media for sending one or more short message service (SMS) requests to a plurality of mobile devices. The article comprises means in the one or more media for receiving one or more SMS reports from one or more of the plurality of mobile devices. The article comprises means in the one or more media for sending one or more portions of information based on the one or more SMS reports to one or more communication devices.

### DESCRIPTION OF THE DRAWINGS

Features of exemplary implementations of the invention will become apparent from the description, the claims, and the accompanying drawings in which:

FIG. 1 is a representation of an exemplary implementation of an apparatus that comprises one or more computer terminals, one or more application server components, one or more databases, one or more short message service centers (“SMSCs”), one or more mobile services switching centers (“MSCs”), one or more wireless packet networks, one or more cell sites, a plurality of mobile devices, the Internet, one or more voice extensible markup language (“XML”) gateways, one or more wired switches, and one or more communication devices.

FIG. 2 is a representation of an exemplary implementation of a short message service (“SMS”) message flow illustrating an employment of SMS requests by the application server component of the apparatus of FIG. 1.

FIG. 3 is another representation of an exemplary implementation of an SMS message flow illustrating an employment of the subset of mobile devices sending SMS reports to the application server component of the apparatus of FIG. 1.

FIG. 4 is a representation of an exemplary implementation a message flow illustrating an employment of the application server component sending the messages to the communication devices of the apparatus of FIG. 1.

FIG. 5 is a representation of an exemplary implementation of a message flow illustrating the communication devices retrieval of information based on the SMS reports from the website servers of the apparatus of FIG. 1.

### DETAILED DESCRIPTION

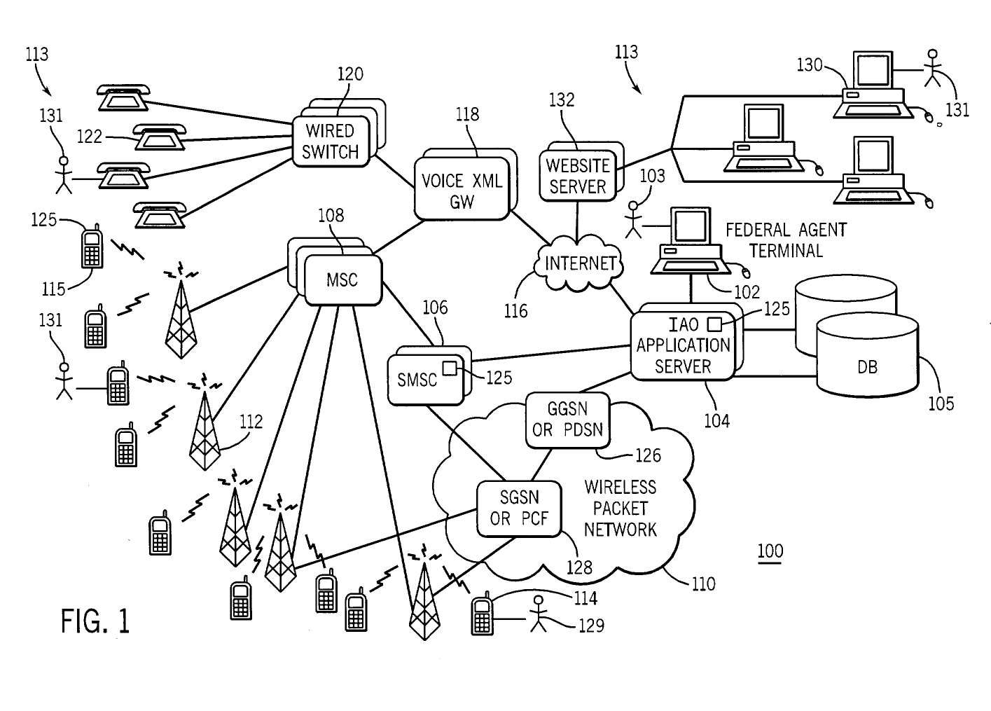

Turning to FIG. 1, an apparatus 100 in one example comprises a plurality of components such as computer software and/or hardware components. A number of such components can be combined or divided in the apparatus 100. An exemplary component of the apparatus 100 employs and/or comprises a set and/or series of computer instructions written in or implemented with any of a number of programming languages, as will be appreciated by those skilled in the art.

The apparatus 100 in one example comprises one or more computer terminals 102, one or more application server components 104, one or more databases 105, one or more short message service centers (“SMSCs”) 106, one or more mobile services switching centers (“MSCs”) 108, one or more wireless packet networks 110, one or more cell sites 112, a plurality of mobile devices 114, the Internet 116, one or more voice extensible markup language (“XML”) gateways 118, one or more wired switches 120, and one or more communication devices 113. The apparatus 100 in one example comprises a telecommunications and/or computer network.

The application server component 104 in one example sends one or more short message service (“SMS”) requests to a subset of the mobile devices 114. For example, the application server component sends the SMS requests to the subset of mobile devices 114 to obtain one or more SMS reports from the subset of mobile devices 114. The application server component employs the SMS requests to prevent network traffic overload and/or to increase a probability of delivery. The subset of mobile devices 114 sends the one or more SMS reports to the application server component 104.

In one example, the SMS reports comprise status indicators of the subset of the mobile devices 114. In another example, the SMS reports comprise status indicators of a set of users 129 associated with the subset of the mobile devices 114. The status indicators in one example comprise a location of the set of users 129. The status indicators in another example comprise a condition of the set of users 129. For example, the status indicators show others if the set of users 129 are available, busy, on the phone, safe, in need of assistance, and the like. The application server component 104 prompts the subset of the mobile devices 114 for the status indicators. For example, the application server component 104 prompts the subset of the mobile devices 114 on a periodic basis.

The application server component 104 stores and/or forwards the status indicators. The communication devices 113 in one example retrieve the status indicators of the set of users 129 from the application server component 104. For example, the application server component 104 sends information based on the SMS reports to the communication devices 113. A set of users 131 of the communication devices 113 employs the information based on the SMS reports to determine the status of the set of users 129. The set of users 129 in one example are in or near a disaster area. The set of users 131 in one example are friends or family of the set of users 129. Thus, the set of users 131 wants to know the status of set of users 129 in the disaster area.

The application server component 104 in one example comprises an instance of a recordable data storage medium 125, as described herein. The application server component 104 in one example utilizes inputs and/or outputs to manage information. For example, the application server component 104 may receive inputs such as SMS messages. For example, the application server component 104 outputs information based on the SMS messages. The application server component 104 is coupled with the computer terminal 102, the short message service center 106, the wireless packet network 110, the voice XML gateway 118, the Internet 116, and/or the database 105. For example, the application server component 104 may store, alter, and/or communicate information between the database 105, the short message service center 106, the wireless packet network 110, the voice XML gateway 118, the Internet 116, and/or the computer terminal 102.

The computer terminal 102 employs inputs from an administrator 103 to affect actions of the application server component 104. In one example, the administrator 103 employs the computer terminal 102 to send outputs to the application server component 104 and/or receive inputs from the application server component 104. For example, the administrator 103 employs a keyboard of the computer terminal 102 to type the inputs for the application server component 104. In another example, the application server component 104 outputs information that affects actions on the computer terminal 102. For example, the administrator 103 employs a monitor of the computer terminal 102 to view the outputs from the application server 104. The administrator 103 in one example comprises a federal agent, a crisis management person, or a corporate assistant.

The database 105 stores information for the application server component 104. The application server component 104 sends information to the database 105 and/or receives information from the database 105. The database 105 in one example serves to store and/or transfer information such as one or more passwords, one or more administrator names, and/or information based on SMS messages. For example, the application server component 104 stores the status indicators of the SMS reports in the database 105. Upon receipt of a request for the status indicators from one or more of the communication devices 113, the application server component 104 retrieves the status indicators from the database 105 to send to the one or more of the communication devices 113.

The SMS messages described herein comprise one or more SMS requests and/or one or more SMS reports. One or more subportions of the SMS reports from the mobile devices 114 comprise one or more notices. The notices comprise text that indicates the status of a set of users 129. The one or more subportions of the SMS reports comprise one or more identifiers.

In one example, the identifiers comprise one or more of mobile device numbers of one or more mobile devices 115, instant message accounts, website addresses, and email addresses of the communication devices 113. The application server component 104 sends messages based on the SMS reports to the communication devices 113. The identifiers indicate which of the communication devices 113 should receive the messages based on the SMS reports.

In another example, the identifiers comprise an indication of one or more identities of one or more users of the set of users 129. For example, the identifiers indicate a source of the SMS reports for the communication devices 113. In yet another example, the identifiers comprise one or more mobile device numbers of the mobile devices 114. For example, a user of the set of users 131 inputs an identifier of a user of the set of users 129 at a website server to request a notice that indicates a status of the user of the set of users 129.

The short message service center 106 stores information and/or communicates SMS messages. For example, the short message service center 106 stores SMS messages from any of the application server 104, the mobile services switching center 108, and/or wireless packet network 110. The short message service center 106 in one example comprises an instance of the recordable data storage medium 125, as described herein. The short message service center 106 serves to send and/or receive SMS messages between one or more of the application server 104, the wireless packet network 110, and/or the mobile services switching center 108.

The mobile services switching center 108 serves as an interface between the short message service center 106, the cell site 112, and/or the voice XML gateway 118. For example, the mobile services switching center 108 establishes communication between the short message service center 106, the cell site 112, and/or the voice XML gateway 118. The mobile services switching center 106 communicates SMS messages between the short message service center 106 and the cell site 112.

Where the mobile service switching center 108 does not communicate the SMS messages, the wireless packet network 110 carries SMS messages between the short message service center 106 and the cell site 112. The wireless packet network 110 in one example may carry instant messages between the application server component 104 and the cell site 112. The wireless packet network 110 in one example comprises one or more gateway general packet radio service support nodes (“GGSNs”) 126 and one or more serving general packet radio service support nodes (“SGSNs”) 128.

The gateway general packet radio service support node 126 transfers information between the application server component 104 and the serving general packet radio service support node 128. The gateway general packet radio service support node 126 in one example comprises a packet data serving node (“PDSN”). The gateway general packet radio service support node 126 in one example communicates instant messages between the application server component 104 and the serving general packet radio service support node 128.

The serving general packet radio service support node 128 transfers information between the short message service center 106, the gateway general packet radio service support node 126, and/or the cell site 112. The serving general packet radio service node 128 in one example comprises a packet control function (“PCF”). The serving general packet radio service support node 128 in one example communicates SMS messages between the cell site 112 and the short message service center 106.

The cell site 112 transfers information between the mobile services switching center 108, the wireless packet network 110, and the mobile devices 114. For example, the cell site communicates SMS messages between the mobile devices 114 and the mobile services switching center 108 or the wireless packet network 110.

The mobile devices 114 send information to the cell site 112 and/or receive information from the cell site 112. The mobile devices 114 in one example serve as an interface for the set of users 129 to send and/or receive SMS messages. The mobile devices 114 comprise an instance of the recordable data storage medium 125, as described herein. The plurality of mobile devices 114 comprises a subset of mobile devices 114. The mobile devices 114 in one example comprise pagers, mobile phones, and personal digital assistants (“PDAs”).

The communication devices 113, may access information based on SMS reports from the application server component 104. For example, the set of users 131 may employ the communications devices 113 to access SMS messages, instant messages, emails, and/or websites. The communication devices 113 comprise one or more of the mobile devices 115, website servers 132, computer terminals 130, and/or telephonic devices 122.

The mobile devices 115 receive information about the cell site 112. In one example, the set of users 131 employ the mobile devices 115 to receive SMS messages. In another example, the set of users 131 employ the mobile devices 115 to access instant messages, emails, and/or websites over the Internet 116. The mobile devices 115 in one example comprise an instance of the recordable data storage medium 125, as described herein. The mobile devices 115 in one example comprise pagers, mobile phones, and personal digital assistants.

The Internet 116 carries information between the application server component 104, the website servers 132, and/or the voice XML gateway 118 for one or more of the communication devices 113. The Internet 116 in one example transfers web pages, instant messages, and/or emails between the application server component 104, the website servers 132, and/or the voice XML gateway 118. For example, the communication devices 113 receive web pages, instant messages, and/or emails over the Internet 116 to retrieve the status of the set of users 129 from the application server component 104.

The website servers 132 host one or more websites. The set of users 131 employs the computer terminals 130 in one example to access information from the website servers 132. For example, the application server component 104 sends information based on the SMS reports to the website servers 132 over the Internet 116. The website servers 132 in one example post the information based on the SMS reports on the one or more websites. Internet users may download the information based on the SMS reports from the one or more websites.

The computer terminals 130 serve as an interface for the set of users 131 to access the website servers 132. The set of users 131 in one example employ the computer terminals 130 to receive email and/or instant messages over the Internet 116 from the website servers 132. For example, the set of users 131 employs the computer terminals 130 to retrieve the status of the set of users 129 from the application server component 104 through the website servers 132. The computer terminals 130 in one example comprise personal computers and/or personal digital assistants. Exemplary ways the computer terminals 130 connect to the Internet 116 comprise dial-up access, cable modems, DSL, Ethernet, wireless as will be understood by those skilled in the art.

The voice XML gateway 118 serves as an interface between the Internet 116, the mobile services switching center 108, and/or the wired switch 120. The voice XML gateway 118 in one example communicates information between the wired switch 120, the mobile services switching center 108, and/or the Internet 116. For example, the voice XML gateway 118 converts text of the status indicators into speech. The voice XML gateway 118 sends the speech to the wired switch 120 for the telephonic devices 122.

The wired switch 120 communicates information between the voice XML gateway 118 and the telephonic devices 122. In one example, the wired switch 120 communicates speech from the voice XML gateway 118 to the telephonic devices 122. For example, the set of users 131 in one example employs the telephonic devices 122 to receive information based on the SMS reports as speech. The telephonic devices 122 in one example comprise telephones.

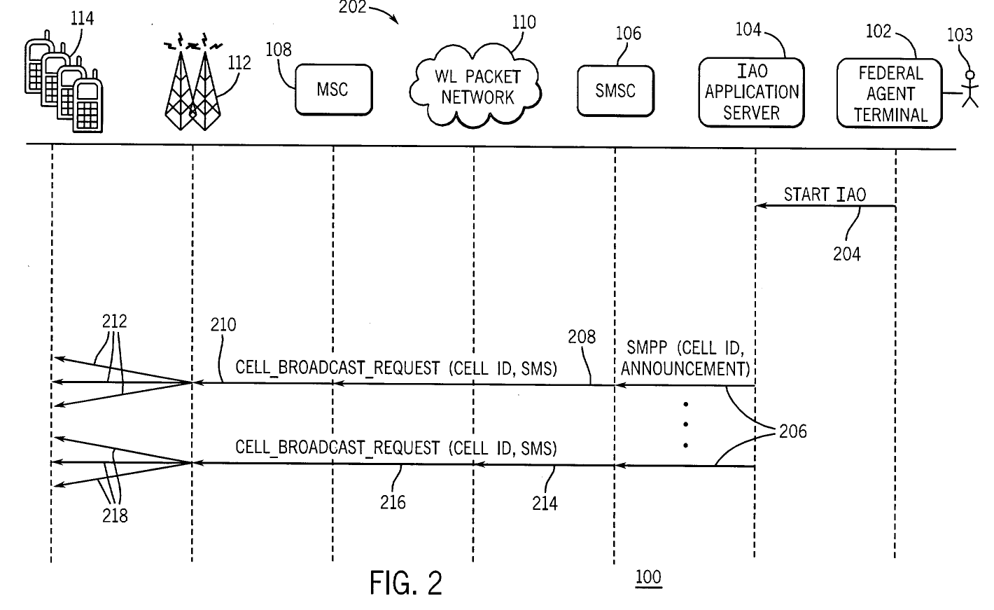

Referring to FIGS. 1 and 2, an illustrative description of exemplary operation of the apparatus 100 is presented, for explanatory purposes. Message flow 202 represents an exemplary employment of SMS requests by the application server component 104. For example, the application server component 104 sends the SMS requests to the subset of mobile devices 114 in response to an emergency situation. The administrator 103 in one example employs the computer terminal 102 to initiate the SMS requests.

The database 105 in one example associates one of the passwords with the respective administrator 103. The administrator 103 inputs the password and the administrator name into the computer terminal 102. The application server component 104 determines if the password matches the respective administrator name in the database 105. If a match exists, then the administrator 103 may access the application server 104.

The administrator 103 employs the computer terminal 102 to send an initiation message 204 to the application server 104. “START IAO” in one example serves to represent the initiation message 204. For example, the administrator 103 employs the computer terminal 102 to create the initiation message that comprises a request for status of the set of users 129. The administrator 103 identifies one or more of the mobile devices 114 to receive the SMS requests. For example, the administrator 103 maps a set of geographical coordinates that represents an area (e.g., a disaster area or a high network traffic area). The application server component 104 determines which of the mobile devices 114 are located within the geographical coordinates by utilizing mobile device tracking software of the application server component 104 as will be appreciated by those skilled in the art.

Upon receipt of the initiation message 204, the application server component 104 sends one or more SMS requests 206 to the short message service center 106. For example, the application server 104 broadcasts the SMS requests 206 to the short message service center 106. “SMPP (CELL ID, ANNOUNCEMENT)” in one example serves to represent the SMS requests 206. “CELL ID” in one example serves to represent the identifiers of the subset of mobile devices 114. “ANNOUNCEMENT” in one example serves to represent the text of the SMS request. The short message service center 106 stores the SMS requests 206 until one or more of the mobile switching center 108 and/or the wireless packet network 110 are ready to receive the SMS requests 206.

In one example, upon receipt of the SMS requests 206, the short message service center 106 sends an SMS request 208 to the mobile services switching center 108. “CELL_BROADCAST_REQUEST (CELL ID, SMS)” in one example serves to represent the SMS request 208. Upon receipt of the SMS request 208, the mobile services switching center 108 sends an SMS request 210 to the cell site 112. Upon receipt of the SMS request 210, the cell site 112 sends one or more SMS requests 212 to the subset of mobile devices 114 for the set of users 129.

In another example, upon receipt of the SMS requests 206, the short message service center 106 sends an SMS request 214 to the wireless packet network 110. “CELL_BROADCAST_REQUEST (CELL ID, SMS)” in one example serves to represent SMS request 214. Upon receipt of the SMS request 214, the wireless packet network 110 sends an SMS request 216 to the cell site 112. Upon receipt of the SMS request 216, the cell site 112 sends one or more SMS requests 218 to the subset of mobile devices 114 for the set of users 129.

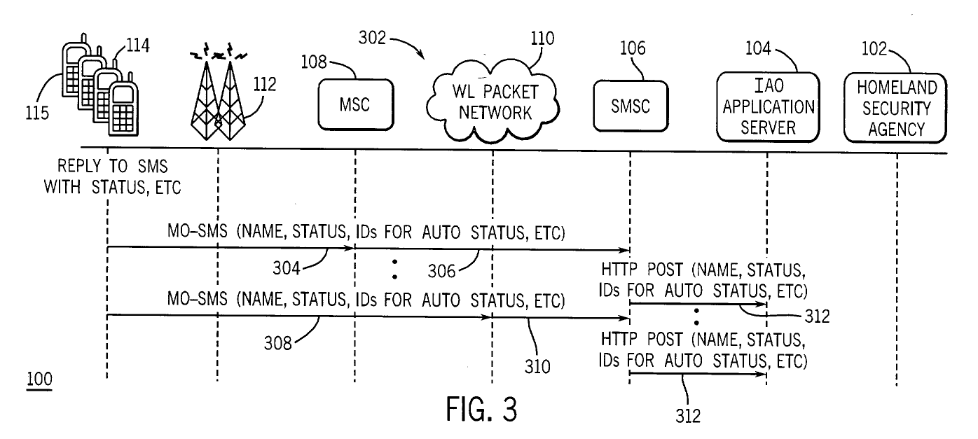

Referring to FIGS. 1 and 3, message flow 302 represents an exemplary employment of the subset of mobile devices 114 to send SMS reports to the application server component 104. The set of users 129 inputs one or more SMS reports 304 into the subset of mobile devices 114. “MO-SMS (NAME, STATUS, IDs FOR AUTO STATUS, ETC)” in one example serves to represent the SMS reports 304. “NAME” in one example serves to represent the identifiers of the subset of mobile devices 114. For example, an identifier comprises a mobile device number and an identity of the SMS reports that correspond to a user of the set of users 129. “STATUS” in one example serves to represent the notices. “IDs FOR AUTO STATUS” in one example serves identify the communication devices 113. For example, the identifiers identify one or more of the mobile devices 115, the website servers 132, and the computer terminals 130. The set of users 129 inputs the notices to indicate to the set of users 131 the status of the set of users 129.

In one example, the subset of mobile devices 114 sends the SMS reports 304 to the mobile services switching center 108. Upon receipt of the SMS reports 304, the mobile services switching center 108 sends SMS reports 306 to the short message service center 106. For example, the short message service center 106 stores the SMS reports 306 for retrieval by the application server component 104.

In another example, the subset of mobile devices 114 sends the SMS reports 308 to the wireless packet network 110. Upon receipt of the SMS reports 308, the wireless packet network 110 in one example sends SMS reports 310 to the short message service center 106. For example, the short message service center 106 stores the SMS reports 310 for retrieval by the application server component 104.

Upon receipt of the SMS reports 306 or the SMS reports 310, the short message service center 106 sends SMS reports 312 to the application server component 104. After the receipt of the SMS reports 306 or the SMS reports 310, the subset of mobile devices 114 in one example may send additional SMS reports to the application server component 104. “HTTP POST (NAME, STATUS, IDs FOR AUTO STATUS, ETC)” in one example serves to represent one or more portions of information that comprise one or more subportions of the SMS reports 306 and 310. The database 105 in one example stores the one or more subportions of the SMS reports. The application server component 104 generates one or more messages that comprise one or more of the one or more subportions of information. For example, the application server component 104 in one example sends the messages to the communication devices 113 for the set of users 131.

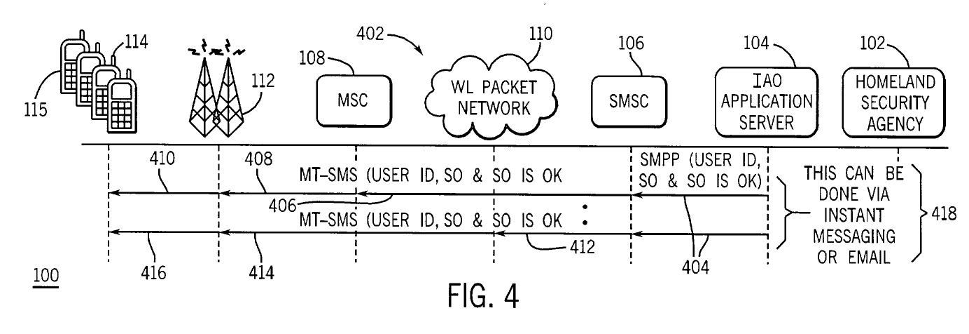

Referring to FIGS. 1 and 4, message flow 402 represents an exemplary employment of the application server component 104 to send the messages to the communication devices 113. Where the SMS reports comprise one or more identifiers of one or more of the communication devices 113, the application server sends the messages that comprise one or more SMS messages 404 to the short message service center 106. “SMPP (USER ID, SO & SO IS OK)” in one example serves to represent the SMS messages 404. “USER ID” in one example serves to represent the identifiers of the subset of mobile devices 114. “SO & SO IS OK” in one example serves to represent the status indicators of the set of users 129.

In one example, upon receipt of the SMS messages 404, the short message service center 106 sends an SMS message 406 to the mobile services switching center 108. “MT-SMS (USER ID, SO & SO IS OK)” in one example serves to represent the SMS message 406. Upon receipt of the SMS message 406, the mobile services switching center 108 sends an SMS message 408 to the cell site 112. Upon receipt of the SMS message 408, the cell site 112 sends an SMS message 410 to the mobile devices 115 associated with the set of users 131.

In another example, upon receipt of the SMS messages 404, the short message service center 106 sends an SMS message 412 to the wireless packet network 110. “MT-SMS (USER ID, SO & SO IS OK)” in one example serves to represent the SMS message 412. Upon receipt of the SMS message 412, the wireless packet network 110 sends an SMS message 414 to the cell site 112. Upon receipt of the SMS message 414, the cell site 112 sends an SMS message 416 to the mobile devices 115 associated with the set of users 131.

In yet another example, where the SMS reports comprise one or more identifiers of one or more of the communication devices 113, the application server component 104 sends messages 418 to the communication devices 113. “THIS CAN BE DONE VIA INSTANT MESSAGING OR EMAIL” in one example serves to represent the messages. For example, the messages comprise one or more instant messages and/or one or more emails. The application server component 104 sends one or more of the instant messages and the emails over the Internet 116 to one or more of the computer terminals 130 and the website servers 132.

Referring to FIGS. 1, 3, and 4, one example of the SMS message flows 302 and 402, a first mobile device of the mobile devices 114 sends a first SMS report to the application server component 104. The SMS report comprises a first identifier of a communication device 113, an identifier of the first mobile device of the mobile devices 114, and a notice from a first user of the set of users 129. For example, the application server component 104 sends a first portion of information based on the SMS report to the first communication device 113. The first portion of information comprises the identifier of the first mobile device of the mobile devices 114 and the notice from the first user of the set of users 129.

As a second example of the SMS message flows 302 and 402, a first mobile device of the mobile devices 114 sends a first SMS report to the application server component 104. The SMS report comprises identifiers of a first communication device of the communication devices 113 and a second communication device of the communication devices 113, an identifier of the first mobile device of the mobile devices 114, and a notice from the first user of the set of users 129. For example, the application server component 104 sends a first portion of information based on the SMS report to the first communication device and the second communication device. The portion of information comprises the identifier of the first mobile device of the mobile devices 114 and the notice from the first user of the set of users 129.

As a third example of the SMS message flows 302 and 402, a first mobile device of the mobile devices 114 sends one SMS report to the application server component 104. The SMS report comprises identifiers of a first communication device of the communication devices 113 and a second communication device of the communication devices 113, identifiers of the first mobile device and a second mobile device of the mobile devices 114, and notices from a first user and a second user of the set of users 129. For example, the application server component 104 sends a first portion of information based on the SMS report to the first communication device of the communication devices 113. The portion of information comprises the identifier of the first mobile device of the mobile devices 114 and the notice from the first user of the set of users 129. For example, the application server component 104 sends a second portion of information based on the SMS report to the second communication device of the communication devices 113. The portion of information comprises the identifier of the second mobile device of the mobile devices 114 and the notice from the second user of the set of users 129.

As a fourth example of the SMS message flows 302 and 402, a first mobile device and a second mobile device of the mobile devices 114 send a respective first and a respective second SMS reports to the application server component 104. The first SMS report comprises an identifier of a first communication device of the communication devices 113, an identifier of the first mobile device of the mobile devices 114, and a notice from a first user of the set of users 129. The second SMS report comprises an identifier of a second communication device of the communication devices 113, an identifier of the second mobile device of the mobile devices 114, and a notice from a second user of the set of users 129. For example, the application server component 104 sends a first portion of information to the first communication device of the communication devices 113. The first portion of information comprises the identifier of the first mobile device of the mobile devices 114 and the notice from the first user of the set of users 129. For example, the application server component 104 sends a second portion of information to the second communication device of the communication devices 113. The second portion of information comprises the identifier of the second mobile device of the mobile devices 114 and the notice from the second user of the set of users 129.

As a fifth example of the SMS message flows 302 and 402, a first mobile device and a second mobile device of the mobile devices 114 send a respective first and a respective second SMS reports to the application server component 104. The first SMS report comprises an identifier of a first communication device of the communication devices 113, an identifier of the first mobile device of the mobile devices 114, and a notice from a first user of the set of users 129. The second SMS report comprises the identifier of the first communication device of the communication devices 113, an identifier of the second mobile device of the mobile devices 114, and a notice from a second user of the set of users 129. For example, the application server component 104 sends a first portion of information to the first communication device of the communication devices 113. The first portion of information comprises the identifier of the first mobile device of the mobile devices 114 and the notice from the first user of the set of users 129. For example, the application server component 104 sends a second portion of information to the first communication device of the communication devices 113. The second portion of information comprises the identifier of the second mobile device of the mobile devices 114 and the notice from the second user of the set of users 129.

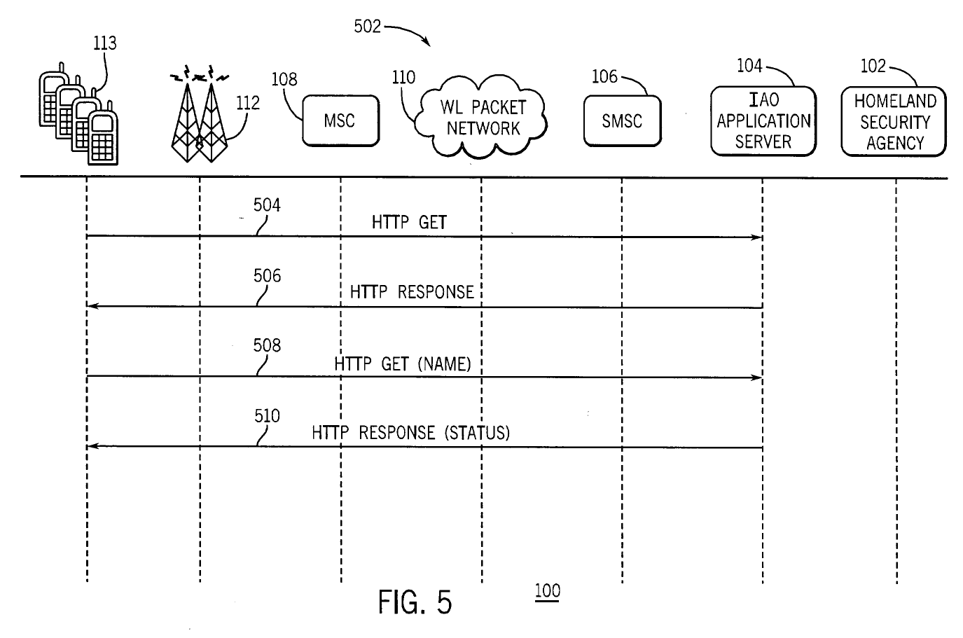

Referring to FIGS. 1 and 5, message flow 502 represents an exemplary employment of the communication devices 113 to retrieve information based on the SMS reports from the website servers 132. The website servers 132 send the information to the set of users 131 through the communication devices 113. The application server component 104 in one example retrieves one or more portions of information from the database 105. For example, the application server component 104 sends the one or more portions of information to the website servers 132. The set of users 131 employs the computer terminals 130, the telephonic devices 122, and/or the mobile devices 115 to access one or more websites of the website servers 132. For example, the communication devices 113 send a retrieve message 504 to the application server component 104. “HTTP GET” in one example serves to represent the retrieve message 504.

The website server 132 presents one or more websites to the set of users 131 through the computer terminals 130, the telephonic devices 122, and/or the mobile devices 114. For example, the website server 132 sends a response message 506 to the communication devices 113. “HTTP RESPONSE” in one example serves to represent the response message 506. The website servers 132 allow the set of users 131 to send one or more requests 508 to the application server component 104 for the portions of information. “HTTP GET (NAME)” in one example serves to represent the requests 508. “NAME” in one example serves to represent the identifiers of the subset of mobile devices 114. The application server component 104 sends a response message 510 to the set of users 131 through the website servers 132. “HTTP RESPONSE (STATUS)” in one example serves to represent the response message 510. “STATUS” in one example serves to represent the response message 410 comprises the status indicators of the set of users 129.

The apparatus 100 in one example employs one or more computer-readable signal-bearing media. Examples of a computer-readable signal-bearing medium for the apparatus 100 comprise the recordable data storage medium 125 of the application server 104, the recordable data storage medium 125 of the short message service center 106, and the recordable data storage medium 125 of the mobile devices 114. For example, the computer-readable signal-bearing medium for the apparatus 100 comprises one or more of a magnetic, electrical, optical, biological, and atomic data storage medium. In one example, the computer-readable signal-bearing medium comprises a modulated carrier signal transmitted over a network comprising or coupled with the apparatus 100, for instance, one or more of a telephone network, a local area network (“LAN”), the Internet, and a wireless network.

The steps or operations described herein are just exemplary. There may be many variations to these steps or operations without departing from the spirit of the invention. For instance, the steps may be performed in a differing order, or steps may be added, deleted, or modified.

Although exemplary implementations of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

We claim:

1. An apparatus, comprising:
an application server component that sends one or more short message service (SMS) requests to a plurality of mobile devices;
wherein the application server component employs the one or more SMS requests to obtain one or more SMS reports from one or more of the plurality of mobile devices;
wherein the application server component sends one or more portions of information based on the one or more SMS reports to one or more communication devices.

2. The apparatus of claim 1, wherein the one or more portions of information comprise one or more subportions of the one or more SMS reports, wherein the application server component sends the one or more subportions of the one or more SMS reports to the one or more communication devices.

3. The apparatus of claim 2, wherein the one or more subportions of the one or more SMS reports comprise one or more identifiers of the one or more of the plurality of mobile devices and one or more notices of the one or more of the plurality of mobile devices, wherein the application server component sends the one or more identifiers and the one or more notices to the one or more communication devices.

4. The apparatus of claim 1, wherein the one or more portions of information comprise a first portion of information and a second portion of information, wherein the application server component obtains the first portion of information from a first mobile device of the one or more of the plurality of mobile devices, wherein the application server component obtains the second portion of information from a second mobile device of the one or more of the plurality of mobile devices;
wherein the one or more communication devices comprises a first set of communications devices and a second set of communication devices,
wherein the application server component sends the first portion of information to the first set of communication devices;
wherein the application server component sends the second portion of information to the second set of communication devices.

5. The apparatus of claim 4, wherein the first portion of information comprises a first SMS report, wherein the first SMS report comprises a first identifier and a first notice, wherein the second portion of information comprises a second SMS report, wherein the second SMS report comprises a second identifier and a second notice;
wherein the application server component employs the first identifier to determine the first set of communications devices from the one or more communication devices, wherein the application server component sends the first notice to the first set of communications devices;
wherein the application server component employs the second identifier to determine the second set of communications devices from the one or more communication devices, wherein the application server component sends the second notice to the second set of communications devices.

6. The apparatus of claim 1, wherein the application server component employs one or more subportions of the one or more SMS reports to identify one or more of the one or more communication devices, wherein the application server component sends the one or more portions of information to the one or more of the one or more communication devices.

7. The apparatus of claim 1, wherein the one or more communication devices comprise one or more mobile devices, wherein the application server component sends the one or more portions of information to the one or more mobile devices.

8. The apparatus of claim 1, wherein the one or more communication devices comprise one or more computer terminals, wherein the application server component sends the one or more portions of information to the one or more computer terminals.

9. The apparatus of claim 1, wherein the one or more communication devices comprise one or more website servers, wherein the application server component sends the one or more portions of information to the one or more website servers.

10. The apparatus of claim 9, wherein the one or more portions of information comprise one or more subportions of the one or more SMS reports, wherein the one or more subportions of the one or more SMS reports comprise one or more identifiers and one or more notices that correspond to the one or more identifiers;
wherein the application server component receives a request for a notice of the one or more notices, wherein the request comprises an identifier of the one or more identifiers that provides an indication of the notice;
wherein the request indicates to the application server component to send the notice to the one or more website servers;
wherein a user may employ a computer terminal to access the one or more website servers to retrieve the notice.

11. The apparatus of claim 1, wherein the plurality of mobile devices comprises a subset of mobile devices;
wherein the application server component employs one or more inputs to identify the subset of mobile devices to receive the one or more SMS requests;
wherein the application server component sends the one or more SMS requests to the subset of mobile devices.

12. The apparatus of claim 11, wherein the application server component receives one or more of the one or more inputs through one or more computer terminals;
wherein the application server component employs the one or more of the one or more inputs to identify the subset of mobile devices to receive the one or more SMS requests.

13. The apparatus of claim 11, wherein the application server component broadcasts the one or more SMS requests to the subset of mobile devices.

14. The apparatus of claim 11, wherein the application server component employs one or more of the one or more inputs to identify one or more geographical areas, wherein the subset of mobile devices are located in the one or more geographical areas;
wherein the application server component sends the one or more SMS requests to the subset of mobile devices.

15. The apparatus of claim 14, wherein the one or more geographical areas comprise one or more of a disaster area and a high network traffic area;
wherein the application server component sends the one or more SMS requests to the subset of mobile devices to promote a prevention of a network traffic overload.

16. The apparatus of claim 14, wherein the one or more SMS reports comprise a status indicator of the one or more of the subset of mobile devices;
wherein the application server component sends the status indicator of the one or more of the plurality of mobile devices to the one or more communication devices.

17. A method, comprising the steps of:
sending one or more short message service (SMS) requests to a plurality of mobile devices;
receiving one or more SMS reports from one or more of the plurality of mobile devices in response to the one or more SMS requests; and
accessing one or more portions of information based on the one or more SMS reports by one or more communication devices.

18. The method of claim 17, wherein the step of sending the one or more SMS requests to the plurality of mobile devices comprises the steps of:
employing one or more inputs to identify a subset of mobile devices of the plurality of mobile devices; and
broadcasting the one or more SMS requests to the subset of mobile devices.

19. The method of claim 17, wherein the step of accessing the one or more portions of information based on the one or more SMS reports by the one or more communications devices comprises the steps of:
employing the one or more SMS reports to identify the one or more communication devices;
extracting the one or more portions of information from the one or more SMS reports; and
sending the one or more portions of information to the one or more of the one or more communication devices.

20. The method of claim 17, wherein the one or more communication devices comprises one or more website servers, wherein the step of accessing the one or more portions of information based on the one or more SMS reports by the one or more communication devices comprises the steps of:
sending the one or more portions of information to the one or more website servers;
receiving, by the website server, one or more requests for the one or more portions of information from one or more computer terminals; and
accessing the one or more portions of information at the one or more computer terminals.

21. The method of claim 17, further comprising the steps of:
employing one or more geographical areas to identify a subset of mobile devices of the plurality of mobile devices located in the one or more geographical areas;
sending the one or more SMS requests to the subset of mobile devices; and
alerting the one or more communication devices of a status of one or more of the subset of mobile devices through employment of the one or more SMS reports.

22. An article, comprising:
one or more computer-readable signal-bearing media;
means in the one or more media for sending one or more short message service (SMS) requests to a plurality of mobile devices;
means in the one or more media for receiving one or more SMS reports from one or more of the plurality of mobile devices in response to the one or more SMS requests; and
means in the one or more media for accessing one or more portions of information based on the one or more SMS reports by one or more communication devices.
